(19) United States
(12) Patent Application Publication
(10) Pub. No.: US 2025/0145893 A1
(43) Pub. Date: May 8, 2025

(54) METHOD FOR PRODUCING A STABILIZED BIOMASS OIL

(71) Applicant: TotalEnergies OneTech, COURBEVOIE (FR)

(72) Inventors: Donia BOUZOUITA, Harfleur (FR); Thomas COUSTHAM, Ablon (FR); Pedro ALVAREZ, Baden (CH)

(73) Assignee: TotalEnergies OneTech, COURBEVOIE (FR)

(21) Appl. No.: 18/832,351

(22) PCT Filed: Feb. 16, 2023
(86) PCT No.: PCT/FR2023/050216

§ 371 Date: Jul. 23, 2024

(30) Foreign Application Priority Data
Feb. 17, 2022 (FR) FR2201376

(51) Int. Cl. C10G 3/00; C10G 47/30; C10G 65/12

(52) U.S. Cl. CPC C10G 3/50; C10G 3/44; C10G 3/57; C10G 3/62; C10G 47/30; C10G 65/12; C10G 2300/1011

(57) ABSTRACT

A method for producing a stabilized biomass oil, which can be used as it stands or separated into streams that can be used for preparing fuels and combustibles and/or for preparing lubricants, or be used in a hydroconversion cracking method, in particular for manufacturing fuels.

### TECHNICAL FIELD

The present invention relates to the field of biomass oils, resulting from a pyrolysis of biomass or from a hydrothermal treatment of biomass, and more particularly stabilization thereof, especially either with a view to use thereof as they are or separated into streams that can be used for preparing fuels and combustibles and/or for preparing lubricants, or with a view to use thereof in a hydroconversion or cracking method, particularly for manufacturing fuels.

### Context of the Invention

Biomass oils, also called “bio-oils”, can be obtained by pyrolysis or hydrothermal liquefaction of biomass. These bio-oils constitute an interesting alternative for producing hydrocarbons from renewable resources and reducing greenhouse gas emissions.

Bio-oils are however complex liquids, consisting of water and a complex mixture of oxygenated compounds (such as aldehydes, ketones, furans, carboxylic acids, compounds of the sugar type, compounds derived from lignin, etc.). The elementary composition thereof is similar to the composition of the starting biomass with in particular a high oxygen content. Table 1 gives orders of magnitude of several characteristics of bio-oils from pyrolysis and hydrothermal liquefaction.

TABLE 1
Properties of bio-oils from hydrothermal
liquefaction and from pyrolysis

| | | Pyrolysis oil |
|---|---|---|
| | | (wood, |
| | Hydrothermal- | lignocellulosic |
| | liquefaction oil | biomass) |
| Elementary | | |
| composition (% m) | | |
| Carbon | >70 | 10-70 |
| Hydrogen | 5-15 | 5-10 |
| Oxygen | 8-20 | 30-55 |
| Nitrogen | 0-10 | 0-2 |
| Sulfur | <2 | <1 |
| Water content (% m) | <15 | 15-30 |
| Viscosity (mPa · s) | from 60 to | 10-100 |
| (50° C.) | 1500 or more | |
| Acid value (mgKOH | 5-200 | 50-250 |
| per gbio-oil) | | |
| Carbonyl content | NG | 3-8 |
| (mol/kg) | | |

These bio-oils are moreover chemically and thermally unstable. Chemical instability is expressed by the change over time in their physicochemical properties (viscosity, water content, solid content, etc.) that may result in a separation into two phases. Thermal instability is expressed by a very rapid change in their properties when they are heated to temperatures above 80° C. Chemical instability is not detrimental for normal subsequent processing operations, in particular in a fluidized-bed catalytic cracker, a hydrocracker or a hydrotreatment or hydrogenation unit. Since these processing operations are implemented at temperatures often very much greater than 80° C., thermal instability on the other hand proves to be problematic.

Because of their particular properties stated above, the use of bio-oils raises numerous problems.

Currently, the main methods for benefiting from these bio-oils are combustion in gas boilers or turbines for producing heat and/or electricity, or the production of bases for chemistry.

To be able to be used in refineries with a view to producing renewable liquid fuels or combustibles (or partially renewable if they are mixed with fuels or combustibles of fossil origin), bio-oils must undergo preprocessing. Such preprocessing may be a hydrotreatment step, for example hydrogenation for stabilizing the bio-oils, and/or hydrodeoxygenation (HDO). Hydrotreatment of a bio-oil is in general implemented in a fixed-bed reactor, typically at a temperature ranging from 80° C. to 450° C. and a pressure of 8 to 20 MPa in the presence of a supported catalyst. Typically, stabilization by hydrogenation is implemented at temperatures from 80° C. to 250° C. and hydrodeoxygenation is implemented at temperatures from 250° C. to 450° C. HDO reactions are favored by high temperatures and pressures. The use of high pressures favors the HDO reaction and makes it possible to reduce the speed of the bio-oil polymerization reactions compared with HDO reactions. However, even at relatively low temperatures at which hydrogenation reactions mainly take place, coking phenomena causing deactivation of the supported catalyst and going as far as clogging the fixed-bed reactor are found. It is then necessary to stop the reactor to proceed with cleaning the same.

### PRIOR ART

Thus, in order to limit coking phenomena, proceeding, before HDO, with a step of stabilizing a pyrolysis oil consisting of a low-temperature hydrogenation in a fix-bed reactor is known (“Bio-oil Stabilization by Hydrogenation over Reduced Metal Catalysts at Low Temperatures”, Huamin Wang et al, ACS Sustainable Chem. Eng. 2016, 4, 5533-5545). Stabilization is achieved by a hydrogenation treatment of the pyrolysis oil at a temperature from 80 to 200° C., at 10.3 MPa with a dihydrogen-oil ratio of 2500 L/L, in the presence of an Ru/TiO₂ supported catalyst. A further deactivation of the catalyst is however observed. The publication “Technology advancements in hydroprocessing of bio-oils”, Alan H. Zacher, et al, Biomass and Bioenergy 125 (2019) 151-168, also describes a stabilization treatment at low temperature (140° C.) of a pyrolysis oil in the presence of dihydrogen and of various catalysts, including an Ru/TiO₂ catalyst, in a fix-bed reactor. It is also explained that a pyrolysis oil cannot be treated at high temperature in a boiling-bed reactor.

In order to avoid the problems of reactor clogging, the document WO 2021/156436 A1 moreover teaches introducing a pyrolysis oil into a slurry-type reactor at a temperature below 100° C. Once inside the reactor, the pyrolysis oil is subjected, in a mixture with another feedstock and in the presence of a catalyst, to a hydrocracking reaction at 300-600° C. at a pressure of 100-200 bar. This document does not mention pre-treatment of the pyrolysis oil.

The document WO 2009/146225 A1 also describes a method for hydroconverting renewable feedstocks of the pyrolysis oil type. The renewable feedstocks (solid or liquid) are co-treated with other liquid feedstocks in a fluidized-bed or boiling-bed reactor or in the presence of a catalyst in slurry phase. The document WO 2010/005625 A2 describes a method for hydroconverting a renewable feedstock such as a pyrolysis oil in the presence of an unsupported catalytic system. The reaction is implemented at a temperature of 300-600° C. at pressures of 1000 to 3000 psi gauge making it possible to deoxygenate and crack the renewable feedstock. No pre-treatment of the pyrolysis oil is described in these two documents.

The document EP 2404982 A1 describes a method for processing heavy feedstocks by hydroconversion in the presence of unsupported catalysts. The feedstock can comprise oils resulting from pyrolysis or hydrothermal treatment of biomass. The hydroconversion is implemented at temperatures of 360° C. to 480° C. The catalysts described improve the hydroconversion without modifying the operating conditions normally used.

The document WO 2014/001633 teaches reducing the formation of coke during a hydrotreatment by co-treating a biomass pyrolysis oil and a crude tall oil, the pyrolysis oil previously having been subjected to pre-treatment. The co-treatment is implemented in the presence of dihydrogen and a supported catalyst at temperatures of 100 to 450° C., but temperatures of 300 to 350° C. are necessary for completely eliminating the oxygen. The pyrolysis oil can be pretreated by various methods including pre-hydrogenation in the presence of a supported catalyst at a temperature of 50 to 350° C.

There is however a need for stabilizing a bio-oil while limiting the problems of catalyst deactivation and for allowing in particular subsequent treatment thereof in a refining unit without risk of formation of coke.

### SUMMARY OF THE INVENTION

The invention aims to provide a method for stabilizing a bio-oil selected from an oil resulting from pyrolysis of biomass and an oil resulting from a hydrothermal liquefaction of biomass. In particular, hydrogenation at temperatures of less than or equal to 250° C. in the presence of an unsupported hydrotreatment catalyst makes it possible to appreciably limit the problems of deactivation of the catalyst.

One object of the invention relates to a method for producing a stabilized biomass oil, comprising:
(a) the provision of a biomass oil selected from a biomass pyrolysis oil, an oil from hydrothermal liquefaction of biomass and mixtures thereof, and of an unsupported hydrotreatment catalyst or of a precursor of an unsupported hydrotreatment catalyst,
(b) the hydrotreatment of the biomass oil provided at step (a) in the presence of dihydrogen and of the unsupported hydrotreatment catalyst or of its precursor provided at step (a) at a temperature of less than or equal to 250° C. and the obtaining of an effluent containing the at least partially hydrogenated biomass oil forming a stabilized biomass oil and the unsupported hydrotreatment catalyst.

In one embodiment, the hydrotreatment step (b) is implemented at a temperature of 50° C. to 250° C., optionally of 80° C. to 200° C., or of 100° C. to 200° C. or of 120° C. to 180° C. or in any interval defined by two of these limits.

In one embodiment, the hydrotreatment step (b) is implemented at a dihydrogen pressure of 5 to 30 MPa, optionally of 7 to 25 MPa or of 7 to 15 MPa, of 8 to 20 MPa or of 8 to 15 MPa or in any interval defined by two of these limits.

In one embodiment, the unsupported hydrotreatment catalyst contains, or consists of, at least one metal selected from the metals in groups 3 to 14. The hydrotreatment catalyst can thus be a compound containing at least one metal. The hydrotreatment catalyst can also be a metal or a metal alloy, for example in powder form.

In one embodiment, step (a) comprises a step of providing a precursor of the unsupported hydrotreatment catalyst. The catalyst precursor can in particular be a compound containing at least one metal selected from groups 3 to 14, this compound being selected from ammonium salts, sulfates, nitrates, chlorides, naphthenates, oxyhydroxides, carbamates, dithioates, oxides, octoates, metallocenes or any other organometallic compound.

The unsupported hydrotreatment catalyst is typically a metallic catalyst, containing a metallic active center, and may be a solid, soluble or not in the biomass oil, or a liquid, soluble or not in the biomass oil.

The catalyst can in particular be solubilized or dispersed in various organic bases, coming from the biomass or from petroleum products or in an aqueous solution, in particular in water. These organic and aqueous bases serve, in particular solely, to form and/or transport the metallic active center to the reactor containing the biomass oil.

In one embodiment, during the hydrotreatment step (b), the unsupported hydrotreatment catalyst is in the state dispersed in the biomass oil, forming therewith a suspension phase or an emulsion phase. A suspension phase (suspension of a solid in a liquid), also called a slurry, is formed when the catalyst is a solid insoluble in the biomass oil. An emulsion phase is formed when the catalyst is a liquid insoluble (non-miscible) in the biomass oil.

When the unsupported hydrotreatment catalyst can be dispersed in the bio-oil, the hydrogenation can then in particular be implemented in a reactor of the slurry type.

In one embodiment, the method according to the invention further comprises:
(c) recovery of the effluent produced at step (b) and separation of the stabilized bio-oil produced at step (b) and of the unsupported hydrotreatment catalyst, and optionally returning the unsupported hydrotreatment catalyst at step (b), or
(c′) recovery of the effluent produced at step (b) and returning part of the effluent produced at step (b) at the entry to step (b), or
(c″) recovery of the effluent produced at step (b) and separation of the effluent into a heavy fraction containing optionally the unsupported catalyst and a fraction lighter than the heavy fraction containing the stabilized bio-oil.

In one embodiment, at least part of the effluent coming from step (b) or (c′) or of the stabilized bio-oil coming from step (c) or of the fraction containing the stabilized bio-oil coming from step (c″) is:
(e) treated in a fluidized-bed catalytic cracker, and/or
(f) treated in a hydrocracker, and/or
(g) treated in a catalytic hydrogenation unit, and/or
(h) treated in a hydrotreatment unit, and/or
(i) used as it stands or separated into streams that can be used for preparing fuels and combustibles such as LPG, petrol, diesel or heavy fuel oil and/or for preparing lubricants.

The effluent coming from step (b) or (c′) or from the stabilized bio-oil coming from step (c) or from the fraction containing the stabilized bio-oil coming from step (c″) can in particular be treated, in part or in whole, in the units (e) to (h) alone or in a mixture with a fossil feedstock normally used in these units, in particular without addition of another feedstock of non-fossil origin. Similarly, this effluent can be used as it stands or separated into streams usable alone or in a mixture with a fuel, combustible or lubricant of fossil origin, in particular without addition of another fuel, combustible or lubricant of non-fossil origin.

### DESCRIPTION OF THE FIGURE

FIG. 1 is a schematic representation of an embodiment of the present invention.

### DEFINITIONS

The terms “comprising” and “comprises” as used here are synonyms of “including”, “includes” or “contains”, “containing”, and are inclusive and without limits and do not exclude additional characteristics, elements of method steps not specified.

The expressions % by weight and % by mass have an equivalent meaning and refer to the proportion of the mass of a product compared with 100 g of a composition comprising it.

“Bio-oil” or “biomass oil” means an oil resulting from the pyrolysis of biomass and/or an oil resulting from the hydrothermal liquefaction of biomass.

“Biomass” means an organic material of the following types: wood (hardwood, softwood), straw, energy cultivations (short-rotation coppice (SRC), very short rotation coppice (VSRC), miscanthus, switchgrass, sorghum, etc.) and forest or agricultural biomass residues such as bark, chips, offcuts, bagasse, household organic waste, etc. The biomass can in particular be selected from lignocellulosic biomass, herbaceous biomass (biomass from plants having a non-ligneous stem), auriferous biomass (plants growing in water or under water such as algae), paper, cardboard, organic household waste, alone or in mixtures.

The biomass may thus comprise (i) biomass produced by a surplus of agricultural land, preferably not used for human or animal food: dedicated cultivations, referred to as energy (ii) biomass produced by tree clearance (forest cultivations; maintenance) or cleaning of agricultural land; (iii) agricultural residues from cultivations, in particular cultivations of cereals, vines, orchards, olive groves, fruits and vegetables, food residues, etc; (iv) forest residues from sylviculture and timber conversion; (v) agricultural residues from animal husbandry (dung, manure, litter, droppings, etc.); (vi) organic household waste (paper, cardboard, green waste, etc.); (vii) industrial organic waste (paper, cardboard, wood, putrescible waste, etc.); (viii) algal biomass, namely biomass formed from algae, for example from microalgae (algal biomass may be a suspension of algae obtained by harvesting algae coming for example from a bioreactor, or an algae residue obtained by dehydration of a suspension of algae) or macroalgae; (ix) herbaceous biomass.

The biomass oil obtained may contain from 8 to 55% by mass oxygen. This oxygen is present in n oxygenated compounds containing at least one hydroxyl (—OH) group and/or at least one carbonyl (>C═O) group. A biomass oil may in particular contain carboxylic acids, ketones, aldehydes, phenols.

“Pyrolysis oil” means here a raw oil resulting from the pyrolysis of biomass, optionally pretreated, for example by vacuum distillation (to eliminate water) and/or filtration/adsorption and/or liquid/liquid extraction. Pyrolysis is a thermochemical decomposition of biomass at high temperature in the absence of oxygen.

The term “pyrolysis” includes various pyrolysis modes, such as, for example, fast pyrolysis, vacuum pyrolysis, catalytic pyrolysis, pyrolysis in the presence of hydrogen, and slow pyrolysis or carbonization, etc. In particular, pyrolysis may be a rapid pyrolysis consisting of a rapid increase (<2 seconds) of the temperature to 300° C.-750° C., leading to the polymerization and fragmentation of the elements constituting the biomass (holocelluloses (cellulose, hemicellulose), lignin), followed by rapid quenching of the degradation products.

“Hydrothermal liquefaction” (or HTL) means a method for thermochemical conversion of biomass using water as a solvent, reagent and catalyst of the organic-matter degradation reactions, the water typically being in a subcritical or supercritical state. This method generally takes place at temperatures from 250 to 500° C. and at pressures of 10 to 25-40 MPa. The reaction times vary from a few seconds to several tens of minutes.

“Fossil feedstock” means a hydrocarbon compound resulting from the processing of crude oil.

“Hydrotreatment catalyst” means a catalyst favoring the incorporation of hydrogen in the products. This type of catalyst is typically a metal catalyst comprising one or more metals in groups 3, 4, 5, 6, 7, 8, 9, 10, 11, 12, 13 and 14 of the periodic table.

### DETAILED DESCRIPTION OF THE INVENTION

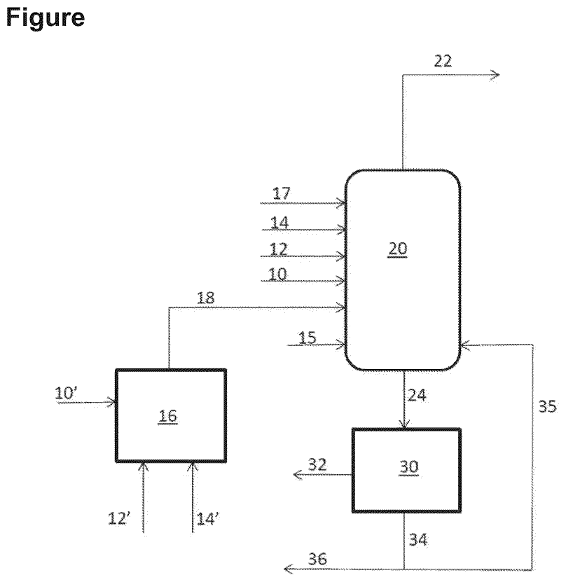

The present invention relates to methods for producing a stabilized biomass oil by hydrogenation using an unsupported metal catalyst. The present invention is described below in general terms with reference to FIG. 1.

FIG. 1 is a schematic representation of an embodiment of a method for producing a stabilized bio-oil of the present invention.

On FIG. 1, the bio-oil to be stabilized is introduced into the hydrotreatment zone 20 via a feed conduit 10. The hydrotreatment zone 20 is furthermore supplied with a compound containing metal via a conduit 12, optionally with a compound containing sulfur via a conduit 14 and with gas containing dihydrogen via a conduit 15.

In one embodiment, as will be seen later, the compound containing metal forms (optionally combined with the compound containing sulfur) an unsupported metal catalyst in the hydrotreatment zone 20.

In another embodiment, also illustrated on FIG. 1, an unsupported metal catalyst is formed and/or activated in the presence of dihydrogen in a receptacle 16 into which, through a conduit 12′, a compound containing metal is introduced, in a mixture or not with a carrier fluid and/or a solvent, optionally a compound containing sulfur through a conduit 14′, the receptacle 16 being heated at temperatures sufficient to form the catalyst from the precursor or precursors. The unsupported metal catalyst (sulfureted or not) thus formed is next brought into the hydrotreatment zone 20 via a conduit 18. In yet another embodiment, the bio-oil to be stabilized can be introduced into the receptacle 16 via a conduit 10′, and the conduit 18 then brings to the hydrotreatment zone a mixture formed by the bio-oil and unsupported metal catalyst.

In another embodiment, an unsupported hydrotreatment catalyst can be introduced directly into the hydrotreatment zone 20 via a dedicated conduit, in a mixture or not with a carrier fluid and/or a solvent as described below.

In one embodiment, it will optionally be possible to introduce an optional promoter into the hydrotreatment zone 20 via the conduit 17.

The bio-oil to be treated is a liquid resulting from the pyrolysis or hydrothermal liquefaction of biomass.

When the catalyst or the precursor thereof is a solid or liquid insoluble in the biomass oil, in order to improve the dispersion of the catalyst in the hydrotreatment reaction zone, the catalyst precursor or precursors or the unsupported catalyst can be combined with a carrier fluid to form a catalyst suspension (slurry) or a catalyst emulsion before adding the catalyst in the hydrotreatment zone. This suspension or emulsion can be produced in the receptacle 16 or in any other vessel. Typically, this suspension or emulsion contains a few hundreds to a few thousands of ppm of catalyst or catalyst precursor diluted in the carrier fluid, and the volume of carrier fluid is thus small compared with the volume of bio-oil to be treated. The carrier fluid can be any type of product known in the art for creating a catalyst suspension or emulsion. In one embodiment, this carrier fluid is a bio-oil as used as a feedstock in the hydrotreatment zone 20, in particular the same bio-oil. In one embodiment, the carrier fluid may be a part of the effluent emerging from the hydrotreatment zone, a byproduct or a part of the stabilized bio-oil obtained in the present invention. In one embodiment, the carrier fluid may be an inexpensive light oil such as a mineral oil. Aqueous solutions of catalyst precursor materials can also be used. These aqueous precursors are generally added to the feedstock (bio-oil) or to a carrier fluid to form an emulsion in which the metal catalyst is formed.

Alternatively, a solution of a catalyst or of a catalyst precursor in a solvent can be produced, for example in the receptacle 16 or in any other vessel. The solvent can be any type of product known in the art for solubilizing a catalyst or a catalyst precursor. The solvent can in particular be water or an oil or bio-oil, in particular of the same nature as the one described for the carrier fluid.

The catalysts used in the present invention are unsupported catalysts. “Unsupported” means that the catalyst does not comprise, and is not associated with, inert support materials such as aluminas, silicas, MgO, carbons, zeolites, oxides, in particular cerium, zirconium or titanium oxides, etc.

The catalyst used in the method of the present invention may be any catalyst known for being useful in a method for hydrotreatment and hydrogenation of petroleum hydrocarbons, in particular in a method in which the catalyst is in suspension (in a slurry) or in emulsion.

For the purposes of the present invention, the hydrotreatment zone comprises an active hydrotreatment catalyst. However, the supply of catalyst may comprise an active catalyst and/or catalyst precursors. In other words, it is not necessary for the supply of catalyst to comprise an active catalyst. Instead of this, the supply catalyst may include one or more precursors that react together or react with ingredients present in the bio-oil or in the hydrotreatment zone to form an active hydrotreatment catalyst in the hydrotreatment zone.

Examples of unsupported catalysts that can be used comprise, without limiting thereto, solid catalysts, soluble or not in the bio-oil to be treated, or liquid catalysts, in particular liquid metal catalysts insoluble in the bio-oil to be treated. The unsupported catalysts can be in sulfureted form or not.

The catalysts may in particular be metals such as cobalt, molybdenum, nickel, iron, vanadium, tin, copper, ruthenium, platinum and other catalysts containing metals in groups 3 to 14. Fine catalytic powders such as powder carbons, geotite, bauxite and limonite can also be used without however serving as a support for any metal catalytic phase. The metals can be added to the reaction zone of the reactor in numerous forms, in particular in the form of metal salts such as ammonium heptamolybdate and iron sulfate. The metals can be added in the form of species soluble in the bio-oil or in water.

The catalysts used in the present invention can in particular be microparticulate solid metal catalysts prepared from catalyst precursor materials such as precursor materials optionally soluble in water, soluble in oil or gaseous. When the catalyst precursor materials are mixed in the presence of heat, the precursor materials form a solid particulate metal catalyst of very small size, which can be sulfureted or not. The solid particulate metal catalyst will generally be formed from nanometric or micrometric particles having for example a mean size of less than 100 microns and preferably less than 20 microns. Forming very small metal catalyst particles can throughout the facilitate dispersion of the catalyst hydrotreatment zone and improve contact of the catalyst with the bio-oil.

The catalyst precursor materials used in the present method comprise a compound containing metal, optionally a compound containing sulfur, and an optional promoter. The compound containing metal will generally be a compound, soluble or not in oil or in water, comprising one or more metals selected from metals such as cobalt, molybdenum, nickel, iron, vanadium, tin, copper, ruthenium, platinum and other metals in groups 3 to 14. Use can for example be made of a compound containing metal soluble in water or in oil comprising one or more metals selected from the group consisting of molybdenum, cobalt, iron, nickel, ruthenium, tin, copper and combinations thereof.

The metal containing compound or the catalyst will be added to the hydrotreatment zone in a quantity by weight that is based on the weight of the metal in the compound/catalyst and is also based on the feed rate of the bio-oil. Generally, the feed rate of metal containing compound/catalyst will be between 50 ppm and up to 5% by mass of metal on the basis of the feed rate by mass of the bio-oil in the hydrotreatment zone. For example, the proportion of metal can be between 100 ppm and 3% by mass of metal. The feed rate by weight of metal in the compound containing metal or the catalyst added to the hydrotreatment zone will depend greatly on the catalytic activity and the activity profile of the metal catalyst.

The metal compounds (soluble or not in oil) that can be used comprise the compounds produced by combining an oxide or oxyhydroxide and a salt of a metal selected from group 3 to 14, including catalysts based on metals derived from an organic acid salt or organometallic compounds of vanadium, tungsten, chromium, iron, molybdenum, etc. Some examples of metal compounds that can be used comprise metallic ammonium salts, metal sulfates, metal nitrates, metal chlorides, in particular metal di- and tri-chlorides, metal naphthenates, metal oxyhydroxides, metal carbamates, metal dithioates, metal oxides, metal octoates, metallocenes and other organometallic compounds, etc.

For example, the precursors containing Mo can be naphthenates or octoates, the precursors containing Ni can be octoates, such as 2-ethyl hexanoate, and the precursors containing V can be acetylacetonate or acetoacetate. Another example of such a metal compound is the product of the reaction of a vanadium catalyst precursor, V₂O₅, and ammonium sulfide that form an ammonium salt of vanadium sulfide as described in U.S. Pat. No. 4,194,967 B1. Other non-limitative examples of metal compounds that can be used dispersed in oil comprise molybdenum naphthenate, nickel di-2-ethylhexanoate, molybdenum dithiocarboxylate, nickel naphthenate, molybdenum hexacarbonyl, molybdenum 2-ethylhexanoate (also known by the name molybdenum octoate), ammonium molybdates, iron naphthenate, molybdenum lithiocarboxylate (MoDTC), and molybdenum lithiophosphate (MODTP). The various examples of precursors can be used alone or in mixtures. Other oil-soluble dispersed catalysts that can be used comprise aliphatic alicyclic molybdenum carboxylic acids and the oil-soluble metallic compound of molybdenum naphthene as described in the document U.S. Pat. No. 4,226,742 B1. Other oil-soluble dispersed catalysts that can be used are disclosed for example in the documents U.S. Pat. Nos. 4,824,821 B1, 4,740,925 B1, 5,578,197 B1 and 6,139,723 B1. Other catalysts that can be used comprising FeSO₄ are disclosed in the document U.S. Pat. No. 4,299,685 B1.

Examples of organometallic coordination compounds that can be used as precursors are the compounds of formula C₁C₂MLn (I), where
M is a metal selected from the group 3, 4, 5, 6, 7, 8, 9, 10, 11, 12, 13 or 14,
—C₁ and —C₂ are monocyclic or polycyclic aryl hydrocarbon ligands that are each bonded by at least one pi bond (typically two pi bonds and one sigma bond) to M, —C₁ and —C₂ being identical or different, each of —C₁ or —C₂ comprising from 0 to 5R substituents, —C₁ and —C₂ being independent or bonded by at least one R substituent, each R substituent being identical or different, R being selected from (i) a monocyclic or polycyclic cyclic structure, substituted or non-substituted, in C3-C8, partially unsaturated, unsaturated or aromatic, fused or not to the —C₁ or —C₂ ligand, (ii) a C3-C8 alicyclic hydrocarbyl radical, substituted or not, partially unsaturated or unsaturated, linear or branched, (iii) a C1-C8 saturated hydrocarbyl radical, substituted or not, linear or branched, (iv) an SiR′2 radical, with R′ identical or different, R′ being selected from a C1-C8 alkyl group, a C3-C8 cycloalkyl group, a C3-C8 aryl group, or a C1-C8 alkoxy group,
L is a ligand that is bonded to M by a sigma bond, n is an integer number between 0 and 3, each -L is, independently, a univalent ligand.

A fused ring is a ring having two carbon atoms and one bond in common with another ring.

An example of an organometallic coordination compound is a metallocene compound having the general formula (C₂R₅)₂MLn (II), where the cyclopentadienyl (C₂R₅) ligands, substituted or not (R representing the hydrogen atom and being defined as in formula (I)), are each bonded to M by at least one pi bond (typically two pi bonds and one sigma bond), and the L ligands are bonded to M by a sigma bond, and where M, L and n are defined as in formula (I).

In formula (I) or (II), M can be selected from the group 3, 4, 5, 6, 7, 8, 9, 10, 11, 12, 13 or 14 of the periodic table of elements, and preferably M is selected from Fe, V or Mo.

In formulae (I) or (II), the -L ligand can be selected from the hydrides (-L=—H), the halides (-L=—F, —Cl, —Br, —I), the “Pseudo-halides” (-L=—CN (cyanide)), the alkoxides (-L=—OR), the thiolates (-L=—SR), the amides (-L=—NR₂), the phosphides (-L=—PR₂), the alkyls (-L=—CH₂R or other), the alkenyls (-L=—CHCHR), the alkynyls (-L=—CCR), the acyls (-L=—COR), the isocyanides (-L=—CNR), nitrosyl (-L=—NO), the diazenides (-L=—NNR), the imides (-L=═NR), -L=-ER₃ or -EX₃ (with E=Si, Ge, Sn), -L=—PR₃, —PX₃, —AsR₃, —SbR₃ and amines, -L=ER₂ (with E=O, S, Se, Te), where X is a halogen atom and R is a C1-C8 alkyl or alkenyl group, preferably in C1-C6, linear or branched, or a C3-C8 alicyclic or aromatic group.

Examples of organometallic coordination compounds that can be used comprise metallocenes, in particular the dicyclopentadienyls of a metal selected from the group 3, 4, 5, 6, 7, 8, 9, 10, 11, 12, 13 or 14 such as dicyclopentadienyl iron (ferrocene, Fe(C₅H₅)₂), molybdenum dicyclopentadienyl (Mo(C₅H₅)₂), or bis(cyclopentadienyl) molybdenum dichloride ((C₅H₅)₂MOCl₂).

Examples of compounds containing water-soluble dispersed metals that can be used as catalyst precursors of this invention comprise, without being limited thereto, sodium molybdate, nickel nitrate, iron nitrate, the water-soluble multi-metal composite catalyst precursors, and water-soluble ammonium heptamolybdate (AHM), ammonium paramolybdate (APM) and ammonium tetrathiomolybdate (ATM).

One or more compounds containing metal can be combined with one or more compounds containing sulfur at a temperature above 250° C., for example from 250° C. to 350° C., in the absence of bio-oil, or at a temperature of 150° C. to 250° C. when the bio-oil to be treated is present, to form the sulfureted metal catalysts that can be used in this invention. Some examples of useful compounds containing sulfur comprise, without being limited thereto, gaseous hydrogen sulfide, organic sulfides such as DMDS, polysulfides, elementary sulfur, sodium sulfide, thiophene, and so on. One or more compounds containing metal can then be combined with one or more compounds containing sulfur at molar ratios of metal to sulfur ranging from at least 1:1.5 to 1:10 or more and preferably at least 1:2 to 1:5 or more. The sulfur in the compounds containing sulfur can for example be combined with the metals in a molar ratio of 2:1 to form a sulfureted metal catalyst. It may be preferable for an excess molar quantity of sulfur to be combined with the compound containing metal to form the sulfureted catalysts.

As indicated above, temperatures of 150° C. to 350° C. are used to initiate the formation of metal sulfureted catalysts from catalyst precursor materials. In addition, dihydrogen must be present before the catalysts can form. Consequently, the point in the hydrotreatment process where the metal sulfureted catalyst is formed can be controlled by controlling the point where the dihydrogen is added in the process.

For example, the dihydrogen can be added to the receptacle 16 to favor the formation of the catalyst outside the hydrotreatment zone 20 of FIG. 1. Alternatively, the precursor materials of the catalyst can be combined in the absence of dihydrogen and directed into the hydrotreatment zone 20 where, in the presence of hydrogen, they react to form a metal catalyst.

The metal catalysts can be used alone or can be further improved by adding small quantities of promoters and/or can be used with other well-known catalyst additives. In one embodiment, small percentages of at least one active metal such as palladium, platinum, nickel, tungsten, cobalt, molybdenum or mixtures thereof are incorporated in the catalysts. It is preferable for a metal in group 4 or groups 8-10 to be combined with the precursors of the catalyst to form a metal catalyst. More preferably, a promoter metal selected from the group consisting of nickel, cobalt or mixtures thereof is incorporated in the unsupported catalyst of this invention. The promoter metal can be added to the catalyst in the form of metal compounds soluble or insoluble in water or oil. If a promoter metal is used, it is preferable for the promoter metal compounds to be in the same class of compound as the compound containing the metal in order to minimize the number of byproducts in the effluent from the hydrotreatment zone. For example, the compound containing the metal is an ammonium compound, then it is preferable, but not obligatory, for the promoter metal also to be an ammonium compound. The optional promoter metal compound can be combined with the other precursor materials of the catalyst before the catalyst is formed. The promoter metal compound can be added to the other catalyst precursor materials in a quantity based on the weight of the metal in the promoter metal compound. Generally, the promoter metal can be combined with the other catalyst promoter materials in a quantity by weight of promoter metal ranging from 0.5% by mass to 15% by mass of the weight quantity of the metal in the compound containing the metal added to the hydrotreatment zone and more preferably at a weight ranging from 1% by mass to 10% by mass.

During the hydrotreatment at low temperature (below or equal to 250° C.), the oxygenated compounds of the bio-oil are mainly converted into alcohols. The products of the hydrotreatment reaction that result therefrom can be used as feedstocks in the conventional processes of manufacturing fuel downstream, including in particular deoxygenation, hydrocracking, etc. treatments, and/or be used as they stand for preparing fuels, combustibles and/or lubricants.

The hydrotreatment zone will comprise an effective quantity of unsupported catalyst. An effective quantity of unsupported catalyst is a quantity sufficient to convert at least a part of the combined feedstock into hydrogenated products. The effective quantity of catalyst that can reside in the hydrotreatment zone varies according to the type and activity of the catalyst selected. For example, the quantity of catalyst can be as small as 100 ppm (on the basis of the weight of catalyst metal). It is also possible for the hydrotreatment reaction to comprise up to 5% by weight a low-activity metal. For example, a large quantity of iron sulfide will probably be necessary to be effective in a hydrotreatment zone because of its low activity. The final choice of catalyst and the quantity used will depend on one or more factors, including, but not limited to, cost, activity, sensitivity to fouling and to poisoning and so on.

Additional additives can be added to or combined with the unsupported catalyst in order to improve conversion of the combined feedstock. For example, it may be useful to associate the catalyst with non-metallic refractory materials such as carbon absorbents, silica, alumina, clays, and similar materials, as long as the unsupported catalyst is not deposited on the surface of the refractory material. Unsupported catalysts can be mixed with refractory materials by well-known methods such as dry mixing, adding the catalyst and refractory material separately in the reaction zone, etc. Other known additives that improve catalytic activity or inhibit the deactivation of the unsupported catalyst can also be added to the catalyst or to the hydrotreatment zone.

As water is present in the bio-oil feedstock, additives that bind to the water or control the pH of the reaction can optionally be added in the reaction zone. At the end of the day, any additive known to a person skilled in the art as being useful in conjunction with the types of unsupported catalyst or the types of method used in the present invention can be added in the hydrotreatment zone or combined with the bio-oil or the catalysts introduced into the hydrotreatment zone.

A gas stream containing dihydrogen is added to the hydrotreatment zone via the conduit 15 to maintain the hydrotreatment pressure in the required range. The gas flow containing dihydrogen can be mainly pure dihydrogen (H₂) or can include additives such as hydrogen sulfide impurities or recycling gases such as light hydrocarbons. Reactive or non-reactive gases can be combined with dihydrogen and introduced into the hydrotreatment zone to maintain the reaction zone at the required pressure.

The hydrotreatment zone of this invention can be selected from any type of hydrotreatment reactor that is useful for implementing hydrogenation of hydrocarbon products in which the unsupported catalyst is mixed with the feedstock, for example in suspension or in emulsion in the feedstock. It is possible in particular to use a boiling-bed or slurry reactor. The hydrotreatment zone can comprise two reactors or more operating at different degrees of reaction or can be a single reactor. A single reactor is preferred in current methods since the inventors discovered surprisingly that hydrotreatment at a temperature of less than or equal to 250° C. in the presence of unsupported catalyst makes it possible to limit the deactivation of the catalyst and the formation of coke while allowing stabilization, and optionally partial hydrodeoxygenation, of the bio-oil. The reactor or reactors of the hydrotreatment zone can operate in batch or continuously.

The hydrotreatment zone will comprise a dynamic catalytic bed. It will be possible to use for this purpose one or more reactors operating as boiling bed or slurry, for example a reactor stirred continuously such as a continuous stirred tank reactor (CSTR). Such reactors are known to a person skilled in the art. Stirring can be obtained by means of a stirring system or a pump.

The hydrotreatment reaction takes place under hydrotreatment reaction conditions sufficient to obtain the required yield of hydrogenated organic compounds, and in particular alcohols, from the bio-oil, in particular to obtain a stabilized bio-oil. A bio-oil comprises numerous oxygenated compounds of the sugar, ketone, aldehyde and carboxylic acid type, as well as unsaturated compounds of the alkene and aromatic type. It can be considered that a bio-oil is stabilized when the compounds of the sugar, ketone, aldehyde and carboxylic acid type are converted, at least partially, into alcohols. It can happen that the unsaturated compounds (alkenes and aromatics) are also partially hydrogenated during stabilization. For example, it can be considered that a bio-oil is stabilized when the carbonyl content thereof is reduced by at least 20%, preferably by at least 30%, 40%, 50%, 60% or at least 80% with respect to the carbonyl content of the biomass oil before stabilization. This carbonyl content, measured in mol/kg, can be determined by means of ASTM E3146-20, or by nuclear magnetic resonance (NMR) of ¹³C as described in the examples.

The reaction conditions generally comprise temperatures ranging from 50° C. to 250° C., preferably from 80° C. to 200° C., more preferably from 100° C. to 200° C. and even more preferably from 120° C. to 180° C. or in any interval defined by two of these limits.

The dihydrogen pressures, in particular at the inlet to the hydrotreatment zone, typically range from 5 to 30 MPa, preferably from 7 to 25 MPa, more preferably from 8 to 20 MPa, and even more preferably from 7 to 15 MPa or from 8 to 15 MPa, or in any interval defined by two of these limits.

The reaction time is typically from 15 minutes to 10 hours, preferably from 30 minutes to 5 hours, more preferably from 30 minutes to 3 hours or from 1 hour to 3 hours, or in any interval defined by two of these limits.

Under these conditions, the hydrocarbon compounds of the bio-oil are hydrogenated without being completely deoxygenated or cracked to form a stabilized bio-oil that can then undergo treatments at high temperature (300° C. or more) in order to form fuels or high-added-value products.

Referring once again to the FIGURE, the reactor/hydrotreatment zone 20 will generally comprise a conduit 22 for discharging gaseous products and a conduit 24 for discharging the effluent containing the at least partially hydrogenated biomass oil forming a stabilized biomass oil and the unsupported hydrotreatment catalyst.

When the unsupported catalyst is a solid not soluble in the biomass oil, the effluent emerging from the hydrotreatment zone 20 forms a phase in suspension that can be directed to a device 30 that effectively separates at least a part of the solid matter in the suspension of the liquid material. The device 30 can be a filter, sludge separators, centrifuges, distillation for eliminating solid, or any other device or apparatus used in treating hydrocarbons for separating or concentrating solids. The liquid effluent can then be recovered via the conduit 32 and treated subsequently in downstream methods for producing in particular fuels. Such a device 30 can also be provided when the unsupported catalyst is a soluble solid or a liquid, for separating any solid impurities and/or sediments present in the effluent and/or the heavy part of the effluent.

In the majority of cases, the liquid effluent emerging from the hydrotreatment zone or from the device 30 will be sent as it stands or fractionated according to distillation temperature ranges for supplying a fluidized-bed catalytic cracker, a hydrocracker, a catalytic hydrogenation unit, a hydrotreatment unit, a pool of fuels or combustibles such as LPG, petrol, jet fuel, diesel, fuel oil (including marine fuels), or a pool of lubricants.

The liquid effluent thus stabilized can thus be treated in the aforementioned units, (fluidized-bed catalytic cracker, hydrocracker, catalytic hydrogenation unit, and/or hydrotreatment unit) while limiting for eliminating the deactivation of the catalysts used and/or the formation of coke, despite the high temperatures used in these units, typically from 500 to 550° C. in a fluidized-bed catalytic cracker, from 100 to 500° C. in a hydrotreatment or hydrogenation unit, and above 230° C., often from 300 to 430° C. in a hydrocracker. This stabilized liquid effluent can be sent partly or wholly into one or more of these units to be treated therein alone or in a mixture with a fossil feedstock.

The residual gas discharged from the hydrotreatment zone 20 via the conduit 22, which can also contain high-value light hydrocarbons, can be treated in traditional refining methods for converting and/or recovering high-value materials such as light hydrocarbons, dihydrogen and so on. The residual gas and the liquid effluent discharged via the conduits 22 and 32 respectively can also be treated in downstream processes for eliminating undesirable contaminants such as water, sulfur, oxygen, etc. When present, the device 30 also produces concentrated sludge discharged through the conduit 34, which can include the unsupported catalyst and/or impurities and/or sediments and/or the heavy part of the effluent. All or part of the concentrated sludge formed in the device 30, optionally containing the unsupported catalyst and/or impurities and/or sediments, can be sent into the hydrotreatment zone 20 via the conduit 35. Alternatively or in combination, all or some of this concentrated sludge can be removed via the conduit 36 in order to be separated, treated, and/or eliminated.

The embodiment of the method according to the invention and the various variants thereof described with reference to FIG. 1 can be implemented in a reactor or reactors operating continuously, and flows of products then circulate continuously in the various conduits, or in a reactor or reactors operating batchwise supplied with reagents at the start of the reaction and the effluents from which are discharged and treated at the end of the reaction.

### Examples

### Method for Determining by NMR the Aldehyde/Ketone and Sugar Content

### Preparing the Sample

A solution of 5 ml of DMSO-d6+Cr(AcAc)₃ is prepared by putting 41+/−2 mg of Cr(AcAc)₃ in a 5 ml calibrated phial to the 5 ml line with DMSO-d6.

The sample is prepared in a phial by adding the sample of bio-oil to the DMSO-d6+Cr(AcAc)₃ solution in the following proportions:
Sample: 230 mg+/−10 mg
DMSO-d6+Cr(AcAc)₃:480 mg+/−10 mg

The preparation is homogenized on a stirred plate and then transferred with a glass pipette into a 5 mm NMR tube. A maximum of 8 samples are prepared at the same time to record the spectra in a time interval of 72 hours.

### Spectrum Recording Conditions:

The NMR ¹³C {¹H} signal is recorded on a 500 MHZ Bruker with a 5 mm BBFO (“Broad Band Fluoride Observation”) probe under the following conditions:
Pulse angle: 90°.
Pulse repetition time: 3 s
Spectral width: 36, 232 Hz centered at 120 ppm
Number of points: 64K
Acquisition time: 0.9 s
Temperature: 25° C.
Rotation: 20 Hz
Number of scans: 6000
Decoupling sequence: inverse-gated decoupling sequence for avoiding the Nuclear Overhauser Effect (NOE), with the Waltz-16 Composite-Pulse Decoupling (CPD) sequence.

### Spectrum Treatment Conditions:

The NMR signal is treated with the Mestre-Nova® software. The ¹³C {¹H} NMR spectrum is obtained by Fourier transform on 64K points after exponential multiplication (line broadening factor=1). The spectrum is put in phase manually, the baseline is corrected automatically with the Whittaker smoothing procedure and the chemical displacement scale is referenced with respect to the DMSO signal at 39.52 ppm.

The regions of the peaks are integrated with the following limits:

| | Chemical |
|---|---|
| | displacement |
| | range (ppm) |
| Carbon of the | 225-183 |
| carbonyl functions | |
| (Aldehydes + ketones) | |
| Carbon of the sugars | 102.95-84.98 |
| (carbon of the | |
| acetal groups) | |

The sum of the surfaces of the peaks is standardized to 100% and the surfaces of the peaks measured are connected directly to the relative abundance of each type of carbon.

### Example of Stabilization of a Wood Pyrolysis Oil

A pine pyrolysis oil obtained by a fast pyrolysis method (FPBO, standing for “fast pyrolysis bio-oil”) having the properties appearing in table 2 was subjected to stabilization by hydrotreatment in the presence of several unsupported catalysts.

TABLE 2
Properties of the FPBO used in the tests

| | Unit | Standard | FPBO |
|---|---|---|---|
| Carbon | (% m) | ASTM D5291-21 | 47.2 |
| Hydrogen | (% m) | ASTM D5291-21 | 6.9 |
| Nitrogen | (% m) | ASTM D5291-21 | <0.5 |
| Sulfur | (% m) | ASTM D5291-21 | <0.5 |
| Oxygen | (% m) | By difference | 45.9 |
| H₂0 | (% m) | ASTM E203-16 (April | 22.7 |
| content | | 2016) (reagent: | |
| | | HYDRANAL ™-Coulomat AK) | |
| Density at | Kg/m³ | NF EN ISO 12185 | 1212.7 |
| 25° C. | | (December 1996) | |

Stabilization tests were implemented in the presence of several catalysts.

The commercial catalysts used are as follows:
Molybdenum octoate: CAS 94232-43-6
Goethite a-FeOOH: CAS 51274-00-1
Ni powder: CAS 7440-02-0

Table 3 sets out the conditions for synthesizing the MoS₂ catalyst from molybdenum octoate.

TABLE 3
Synthesis of MoS₂

| | | | | Quantity |
|---|---|---|---|---|
| | Pressure | H₂ | Quantity of | of Mo |
| Temperature | (bar) | throughput | DMDS (g) | octoate (g) |
| Temperature 1, | 150 | 20 Nl/h | 20 | 60 |
| ° C. 150 | | | | |
| Ramp 1, | | | | |
| ° C./min 10 | | | | |
| Temperature 2 | | | | |
| ° C. 250 | | | | |
| Duration 2 | | | | |
| min 10 | | | | |
| Ramp 2, | | | | |
| ° C./min 5 | | | | |
| Temperature 3, | | | | |
| ° C. 320 | | | | |
| Duration 3, | | | | |
| Min 15 | | | | |

The tests were implemented in a 100 mL semi-batch reactor having an inside diameter of 4.1 mm. This was a stainless-steel reactor that can achieve reaction temperatures of up to 500° C. and pressures of up to 170 barg allowing continuous injection of dihydrogen.

The tests were implemented at temperatures between 12° and 150° C. (Table 4) at a hydrogen pressure and throughput of 120 bar (12 MPa) and 50 NL/h respectively. The stirring speed was 1300 rpm. The reaction time varies from 30 minutes to 2 hours (see Table 4). 60 g of feedstock was treated for each test. DMDS (0.2 mL) was added to the molybdenum octoate in order to activate it.

The tests were implemented in the following manner. First, heating is initiated manually to reach 50° C. Next the pressure rise, stirring and injection of hydrogen are initiated in their turn at this temperature. The temperature rise to reach the final temperature, 120° C. or 150° C., lasts for 15 minutes. Then it is kept stable for 30 minutes to 2 hours according to the tests to favor the catalytic reaction. Finally, stopping the heating makes it possible to reduce the temperature to reach 50° C. in 15 minutes.

TABLE 4
Test operating conditions

| | | T | Reaction | Catalyst |
|---|---|---|---|---|
| Test | Catalyst | (° C.) | time: | (ppm) |
| T1 | Molybdenum | 120° C. | 2 h | 1500 |
| | octoate: | | | |
| T2 | Goethite | 150° C. | 30 min | 1500 |
| | a-FeOOH: | | | |
| T3 | MoS₂ | 150° C. | 2 h | 5000 |
| T4 | Ni | 150° C. | 2 h | 3000 |

The liquid effluent produced by each test is formed by two liquid phases with different viscosities, a first phase (phase 1) containing an appreciable quantity of water (approximately 50% vol), less viscous than a second phase (phase 2), containing mainly organic compounds. In order to facilitate analysis of the aldehyde/ketone and sugar contents of the effluent, the two phases were separated and then analyzed by NMR of the ¹³C, in accordance with the previously described method. The yields of each phase are presented in Table 5.

TABLE 5
Yield of liquid phases

| | Phase 1 | Phase 2 (more |
|---|---|---|
| Test | (% m) | viscous) (% m) |
| T1 | 15.1 | 84.9 |
| T2 | 26.3 | 73.7 |
| T3 | 51.6 | 48.4 |
| T4 | 25.2 | 74.8 |

Table 6 presents the aldehyde and ketone and sugar contents of the feedstock before treatment and after treatment measured by NMR of 13C, in accordance with the previously described method. The contents after treatment correspond to the contents of the two recovered phases, namely of the whole of the effluent produced.

These results show that a low-temperature hydrogenation treatment in the presence of an unsupported catalyst makes it possible to reduce the aldehyde/ketone and sugar contents of the feedstock and consequently to stabilize it. The effluent thus stabilized can thus be sent to a subsequent treatment (alone or in a mixture with a fossil feedstock), for example to manufacture a fuel, combustible, lubricant, etc.

TABLE 6
Analysis of the feedstock before treatment
and of the liquid effluent produced.

| | Aldehydes/ketones | Sugars |
|---|---|---|
| Test | (% m) | (% m) |
| Starting | 6.0 | 7.0 |
| feedstock | | |
| T1 | 2.5 | 2.7 |
| T2 | 3.1 | 2.6 |
| T3 | 4.5 | 3.6 |
| T4 | 4.2 | 2.3 |

1.-10. (canceled)

11. Method for producing a stabilized biomass oil, comprising:
(a) the provision of a biomass oil selected from a biomass pyrolysis oil, an oil from hydrothermal liquefaction of biomass and mixtures thereof, said biomass oil containing 8 to 55% by mass oxygen, this oxygen being present in oxygenated compounds of the sugar, carboxylic acid, ketone, aldehyde and phenol type, and of an unsupported hydrotreatment catalyst or of a precursor of an unsupported hydrotreatment catalyst, said hydrotreatment catalyst or hydrotreatment catalyst precursor containing, or consisting of, at least one metal selected from the metals in groups 3 to 14,
(b) the hydrotreatment of the biomass oil provided at step (a) in the presence of dihydrogen and of the unsupported hydrotreatment catalyst or of its precursor provided at step (a) at a temperature of less than or equal to 250° C., at a dihydrogen pressure of 5 to 30 MPa and a reaction time of 15 minutes to 10 hours, and the obtaining of an effluent containing the at least partially hydrogenated biomass oil forming a stabilized biomass oil and the unsupported hydrotreatment catalyst, the stabilized biomass oil containing compounds of the following type:
sugars, ketones, aldehydes and carboxylic acids at least partially converted into alcohols, and having a carbonyl content reduced by at least 20% with respect to the carbonyl content of the biomass oil provided at step (a).

12. Method according to claim 11, wherein the hydrotreatment step (b) is implemented at a temperature of 50° C. to 250° C., optionally of 80° C. to 200° C., or of 100° C. to 200° C. or of 120° C. to 180° C.

13. Method according to claim 11, wherein the hydrotreatment step (b) is implemented at a dihydrogen pressure of 7 to 25 MPa or of 7 to 15 MPa.

14. Method according to claim 11, wherein the precursor of the unsupported hydrotreatment catalyst is a compound containing at least one metal selected from groups 3 to 14, this compound being selected from ammonium salts, sulfates, nitrates, chlorides, naphthenates, oxyhydroxides, carbamates, dithioates, oxides, octoates, metallocenes, or any other organometallic compound.

15. Method according to claim 11, wherein, during the hydrotreatment step (b), the unsupported hydrotreatment catalyst is in the state dispersed in the biomass oil, and forms therewith a phase in suspension or a phase in emulsion.

16. Method according to claim 11, furthermore comprising:
(c) recovery of the effluent produced at step (b) and separation of the stabilized bio-oil produced at step (b) and of the unsupported hydrotreatment catalyst, and optionally returning the unsupported hydrotreatment catalyst at step (b).

17. Method according claim 11, furthermore comprising:
(c′) recovery of the effluent produced at step (b) and returning part of the effluent produced at step (b) at the entry to step (b).

18. Method according to claim 11, furthermore comprising:
(c″) recovery of the effluent produced at step (b) and separation of the effluent into a heavy fraction containing optionally the unsupported catalyst and a fraction lighter than the heavy fraction containing the stabilized bio-oil.

19. Method according to claim 11, wherein at least part of the effluent coming from step (b) or (c′) or of the stabilized bio-oil coming from step (c) or of the fraction containing the stabilized bio-oil coming from step (c″) is:
(e) treated in a fluidized-bed catalytic cracker, and/or
(f) treated in a hydrocracker, and/or
(g) treated in a catalytic hydrogenation unit, and/or
(h) treated in a hydrotreatment unit, and/or
(i) used as it stands or separated into streams that can be used for preparing fuels and combustibles such as LPG, petrol, diesel or heavy fuel oil and/or for preparing lubricants.
